(19) United States
(12) Patent Application Publication
(10) Pub. No.: US 2007/0244828 A1
(43) Pub. Date: Oct. 18, 2007

(54) AGGREGATE LICENSING

(76) Inventor: Mahmoud Shahbodaghi, Garrison, NY (US)

Correspondence Address: Dennis M. Carleton, Esquire;Fox Rothschild LLP, 29th Floor, 625 Liberty Avenue, Pittsburgh, PA, 15212, US

(21) Appl. No.: 11/734,523

(22) Filed: Apr. 12, 2007

Related U.S. Application Data
(60) Provisional application No. 60/791,577, filed on Apr. 12, 2006.

(51) Int. Cl. H04L 9/00

(52) U.S. Cl. 705/59

(57) ABSTRACT

A system and method for the on-line licensing of reproducible digital works includes a listing service which allows a plurality of ad-hoc offers to be aggregated to create a licensing fee minimally acceptable to the creator of the work. All qualified contributors to the aggregated fee are thereafter entitled to a license to a reproduction of the work. The system allows the creator of the work to list the work on-line and specify a minimally acceptable licensing fee. The system keeps track of all offerors and their respective offers until the sum of the offers exceeds the minimum licensing fee specified by the owner of the work. The licensing fees are then collected from all offerors and the work is distributed. A listing fee may be extracted from the aggregate fee to be paid to the owner of the work.

### RELATED APPLICATIONS

This application claims the benefit of U.S. Provisional Application Ser. No. 60/791,577, filed Apr. 12, 2006.

### BACKGROUND OF THE INVENTION

The traditional model for the sale and/or licensing of property covered by some form of intellectual property protection consists of the sale of a hard media containing the licensed property, for example, a printed book, compact disk containing music or software, DVD, tape, and, earlier, records. These products therefore required manufacturing and distribution by third parties other than the author, such as a publisher or a record label, a distributor, and a retailer.

There are generally four stages between the time a licensor creates a product and the time the licensee acquires a copy of that product. These four stages are: production, marketing, distribution and sales.

Production consists of transferring a final version of the product onto the appropriate media and mass producing it. A written work may be typeset and illustrated, put into book form, and mass produced. A music compilation is mastered, put onto magnetic tape or compact disc, and mass produced. A film is edited, put on magnetic film or DVD, and mass produced. Traditionally, production has been a separate discipline outside the licensor's means, usually requiring contracts and concessions, and, of course, costs at each stage of the process.

With advances in digital technology, licensors are capable of production on their own or with minimal outside help. Traditional distribution has been via the shipping of the hard media via conventional shipping methods, from the producer to the retailer, but becomes much simpler with digital works, which can be shipped via the internet. Even with respect to marketing, licensors are in a better position since communication with their audience has also improved with the advent of the internet.

Therefore, there are fewer reasons today why a licensor can not effectively deal directly with his audience, circumventing inequitable and cumbersome traditional obstacles. Additional value-added costs at each stage of the process, from creator to consumer, adds to the final price of the product. As a result, the authors or creators of these works received only a small share of the purchase price paid by the consumer.

As an example, consider The Beatles, who, in 1962, recorded their first single, “Love Me Do”. They signed a contract with Parlophone Company, in which they gave up all rights to the song for a period of 10 years. The band's share of revenues was one penny per single sold in the U.K. and a half of a penny for each overseas sale. Twenty-five percent of the proceeds went to the band's business manager. The typical retail price of a record of the song in 1962 was 50 pennies, of which The Beatles would split ¾ of a penny between the four members of the band, or about 1.5% of gross. The other 98.5% went to middlemen. If a million copies were sold, the band would receive £7,500, or £1,875 per band member.

The inequities are not just financial. Talented writers, artists, filmmakers, musicians, software engineers and innovators, who are seldom adept at business negotiations, are separated from their audience by an obstacle course of middlemen who often do not recognize the product's value and potential.

However, unlike in the past, licensors are now capable of distributing their works across the internet, especially through high-speed connections. Intellectual property in the digital age consists essentially of bits, not atoms. The fact that heretofore intellectual property was converted to atoms, or hard copy, and treated like tangible goods is, to this extent, an outdated model. The present invention capitalizes on the new paradigm to re-write the relationship between licensors and licensees.

The new model, enabled by the internet, of digital distribution of these types of works can eliminate the need for publishers, distributors and retailers, allowing the creators of the works to realize a greater share of the purchase price paid by the consumer. Therefore, a greater number of sellers should now be able to deal directly with the end consumers of their products.

However, the successful offering of new intellectual property directly to the consumer has not realized it's fullest potential because of the lack of a comprehensive revenue model for its online sale. The most successful model in this area has been the distribution of songs via such services as iTunes®. However, several problems exist with this model. First, most songs offered on iTunes® sell for the same price, without differentiation in price for popularity. Additionally, even this form of distribution, while eliminating the producer and distributor, still requires a retailer as the direct interface with the end consumer, thereby reducing the profits realized by the creators.

Another example of the online distribution of intellectual property is the web site YouTube®, which allows the on-line viewing of videos which have been posted by users of the site. Many videos have achieved significant notoriety through a posting on YouTube®, however, YouTube® currently offers no model of how to generate a licensing fee back to the original poster of the video.

Therefore, it would be advantageous to provide a business model whereby creators of intellectual property are able to offer their works directly to the end consumer at a price set by the market based on demand for the work.

### SUMMARY OF THE INVENTION

A business method which allows individual artists to mass license their works at market price, referred to as aggregate licensing, is disclosed herein. To facilitate the method, a web-based application is provided for tracking the transactions, collecting payment, and facilitating distribution of the product.

In this method, a licensor offers his products for licensing. These works are typically non-tangible, electronically deliverable data, and may include works such as:
Articles, reports, research, commentary, recipes, satire, books, etc.
Music, interviews, readings, debates, speeches, webcasts, etc.
Video clips, films, documentaries, animations, cartoons, photographs, etc.
Streaming live events such as concerts, sporting events, debates, etc.
Software, online help, real-time tech support, advice, how-to's, etc.

The product is listed online, typically on a web site, together with an introduction, table of contents, excerpts, pictures, audio or video clips, reviews, critiques, and other promotional material that might help describe the product and generate interest, and is offered for licensing to end consumers. There is a listing fee that is charged to the potential licensor. The price at which the work is listed represents a minimum license fee (Pᵢ) that the artist is willing to accept for the work. This minimum license fee must be equaled or exceeded by offers from any number of potential licensees before the work is licensed to any one of the potential licensees. Potential licensees decide to make a contributing offer to the total license fee in an amount which they are willing to pay for the license. When the aggregate of the contributions (P_{A}) from a number of potential licensees equals or exceeds the minimum license fee (Pᵢ) set by the licensor, the work is distributed to all of the contributors to the aggregate license fee. As a result, some licensees will pay more or less than other licensees for the same license.

There may be a required minimum offer amount (Oₘᵢₙ) so that only offers that exceed this minimum count towards the aggregate license fee. Once the minimum license fee is reached, all offers above the minimum offer amount are entitled to receive a copy. Either or both of the minimum aggregate license fee and the minimum acceptable offer may be disclosed or concealed, at the discretion of the licensor.

A special format for the listing may allow floating variables. This would allow principles to fine-tune various aspects of the listing during the listing period in order to optimize their interests. For example, the licensor may be allowed to adjust the minimum aggregate licensing fee and/or minimum acceptable offer, while the prospective licensee may be allowed to adjust his offer or make the offer valid for a finite duration. One example would be the case when a licensor realizes that a majority of received offers are below the minimum acceptable offer originally set by the licensor, but are significant enough by volume that it would warrant the lowering of the minimum acceptable offer to include those offers in the aggregate offer. Another example would be the case of a live event promoter who, shortly before the start of the event, sets the minimum acceptable offer based on a calculation of his optimized revenue.

Unless the product is time sensitive material, the listing may remain open indefinitely, until the minimum aggregate license fee is reached, or for a set period as stipulated by the licensor or the online site hosting the offering. In case of live events, the listing will end on or about the start time of the event.

Once the minimum aggregate license fee is reached, all qualified offers will be processed and the licensees notified. A copy of the product is sent or made available for download to all successful licensees. If the minimum aggregate license fee is not reached, then the work remains unlicensed and undistributed. The listing web site may choose to charge a listing fee which may be paid regardless of the outcome of the offering, or only when the artist is successful in licensing his work.

As an example of how the aggregate licensing works, consider an independent film maker who presents a film on a website designed to handle aggregate licensing transactions. The film is listed together with a description, trailer, reviews, etc. The film maker asks for offers for a single downloadable full length digital copy. The minimum that the film maker would be satisfied with is $15,000, so he sets the minimum aggregate license fee (Pᵢ) to that amount. He may choose to reveal the amount of the minimum aggregate license fee, or not. He starts receiving tens, hundreds, or thousands of offers of various amounts: 10 Cents, 50 Cents, $1.00, $5.00, etc. As the offers come in, the web application on the site where the work is listed tracks the cumulative sum of all the offers. The film maker may have set a minimum offer for his work. If this is the case, then only offers above this minimum are counted towards the total. Once the aggregate total of all the offers above the minimum offer amount reaches $15,000.00, everyone who made a qualified offer receives a copy of the film. At this point, the filmmaker can decide to keep the item open for additional offers under the same terms, or change some of the terms and re-list it.

The advantage for the film maker in this situation is that no middlemen stand between the film maker and the end consumers, so the filmmaker receives the entire licensing fee, minus any listing fees. Additionally, the artist retains the copyright rights in his work.

### DESCRIPTION OF DRAWINGS

FIG. 1 is a schematic representation of the web server and application for executing the present invention.

FIG. 2 is a flow chart of the primary embodiment of the invention.

FIG. 3 is a flow chart of an enhanced embodiment of the invention.

### DETAILED DESCRIPTION OF THE INVENTION

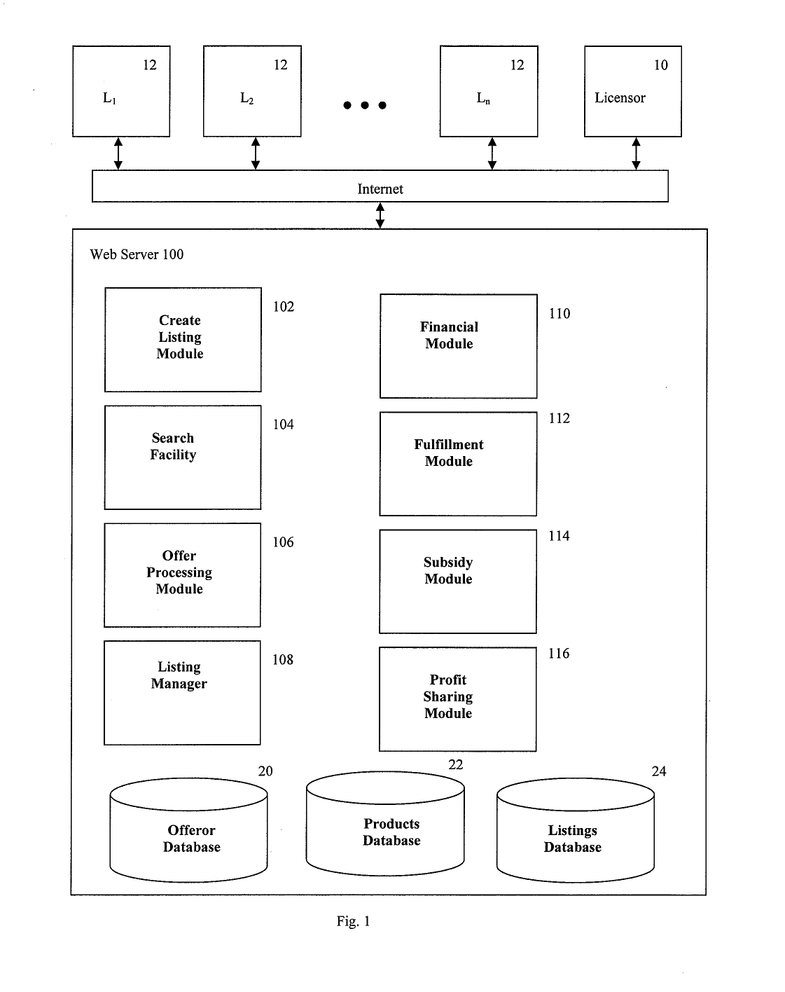

FIG. 1 shows one possible configuration of a computer network and web server capable of supporting the process of the present invention. Note that the configuration shown in FIG. 1 is only one of many possible implementations of the invention and the invention is not meant to be limited to this particular configuration. Web server 100 may be run on any appropriate computer, preferably having a high speed internet connection.

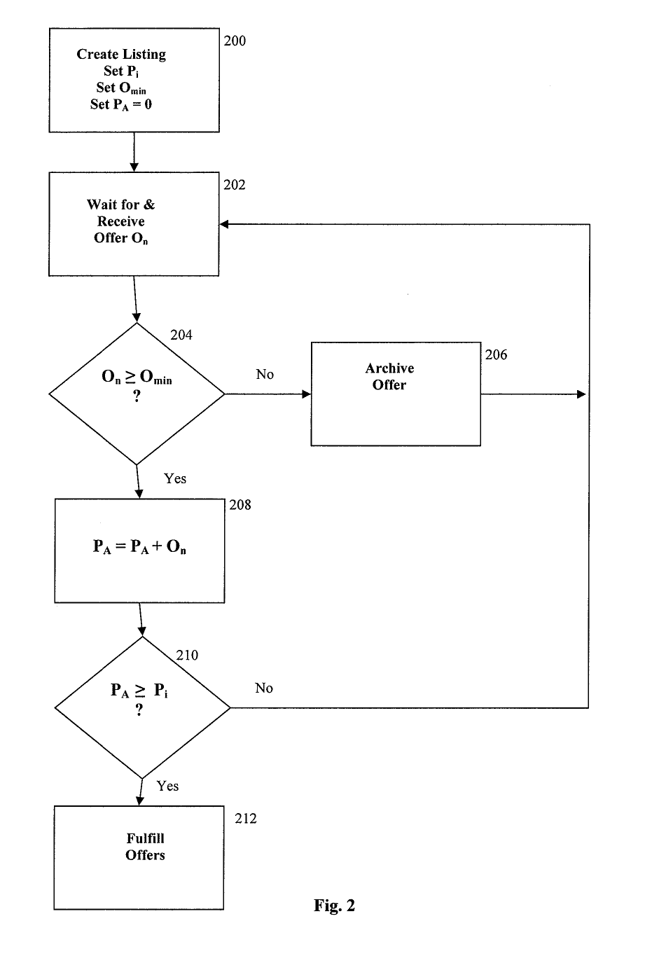

The preferred embodiment of the invention is shown in flow chart form in FIG. 2. In box 200, licensor 10 creates a listing of his work on the web server. In this process, the licensor is able to set the minimum aggregate licensing fee acceptable (Pᵢ). The licensor may also optionally set a minimum offer amount (Oₘᵢₙ) or may choose to allow offers of any amount to count toward the aggregate licensing fee. Additionally, the total aggregate licensing fees offered (P_{A}) is set to zero. In box 202, offer Oₙ is received from a potential licensee. In box 204, if there is a minimum offer amount, the offer is checked to make sure that it is greater than or equal to the minimum acceptable offer Oₘᵢₙ. Should the offer be below the minimum acceptable offer, the offer will be archived in box 206, and control will return to box 202 to await the next offer.

Offers falling below the minimum acceptable offer are archived for at least three possible reasons. First, those submitting offers less than a minimum acceptable offer may be given a chance to raise their offer to a set amount at a later time. Second, during subsequent listing(s) under new terms, the offer may qualify to be counted toward the aggregate licensing fee, for example, if the potential licensor has lowered the minimum acceptable offer. Additionally, because the minimum acceptable offer may be adjusted throughout the duration of a special version of the offering, the licensor may choose to lower the minimum acceptable offer to include a greater number of offers in the aggregate offer.

In box 204, if it is determined that the current offer is greater than the minimum acceptable offer, processing proceeds to box 208 where the aggregate offer (P_{A}) is increased by adding the current offer to the previous aggregate offer (i.e., the sum of all previous offers.) In box 210 a comparison is done between the current aggregate offer (P_{A}) and the minimum acceptable licensing fee (Pᵢ) specified by licensor 10. If the current aggregate offer (P_{A}) does not exceed the minimum acceptable licensing fee (Pᵢ) processing returns to box 202, where the process waits for the next offer to be received. If the current aggregate offer (P_{A}) does exceed the minimum acceptable aggregate offer (Pᵢ) then processing moves to box 212 where all acceptable offers contributing to the total aggregate offer are fulfilled.

Referring back now to FIG. 1, licensor 10 uploads content via the internet to web server 100, where it is stored in products database 22. The content in this case consists essentially of the work that the licensor wishes to license and may be, for example, music, videos, software, text or any other kind of work which is in digital format and which may be delivered via the internet.

Licensor 10 may then create a listing via the create listing module 102. Listings may include descriptions of the work and any additional type of advertising or promotional material that licensor 10 wishes to post to entice potential licensees to make offers or to entice potential licensees to make higher offers. This may include, for example, excerpts, pictures, audio or video clips, reviews of the work and any other promotional materials typically used for such items. Create listing module 102 will arrange the listing into a formatted web page which can be viewed by potential licensees 12 through the internet. The listing, as well as any supporting promotional materials, are stored in listings database 24

Potential licensees 12 can log on to web server 100 and register as an official offeror. Information regarding all individuals making offers is kept in the offeror database 20. Potential licensees 12 can utilize the search facility 104 on the web server 100 to locate listings in which they may be interested, perhaps by subject matter, by author or by any other criteria available to segregate the various listings.

After reviewing the web page describing a particular work, potential licensee 12 may decide to make an offer. All offer processing is performed by offer processing module 106. If a minimum acceptable offer has been established for the listing, the offer processing module will determine if the offer is greater than the minimum acceptable offer and, if so, will record the offer in the listings database 24. The aggregate offer is also updated to include the newly received offer.

Listing manager 108 tracks the overall listing and makes a determination as to when the listing should end, either via the expiration of a preset duration set by potential licensor 10 or by the hosting web site 100, or by determining that the aggregate of all acceptable offers received and processed by offer processing module 106 have exceeded the minimum aggregate license fee set by licensor 10.

Financial module 110 is responsible for all transfers of funds at the conclusion of a listing. Financial module 110 will extract the amount of the offers from all successful offerors 12 at the conclusion of the listing. Payment from offerors 12 may be made in traditional ways payment is made for typical internet e-commerce sites, such as via a third party payment facility, like PayPal®, or directly via credit card. Financial module 110 will also arrange payment to licensor 10 and is also responsible for extracting the listing fee retained by the web server 100 for the listing services. Listing fees may be a percentage of the aggregate offer or may be a flat fee. Additionally, listing fees may be collected at the time of the listing, only after the minimum aggregate licensing fee has been reached, or a combination of both.

Fulfillment module 112 is responsible for making the licensed product available to successful offerors 12. Depending upon the type of product, the product may be sent via email to all successful offerors 12 or may be made available for download from web server 100. In any case, fulfillment module 110 is responsible for notifying successful licensee that their offer has been successful and for arranging, via whatever method, the delivery of the product from products database 22 to successful offerors 12.

Once licensor 10 receives the initial aggregate licensing fee, he may choose to re-list the product for further licensing. The minimum aggregate licensing fee at which the product is subsequently listed may be different than the original minimum aggregate licensing fee and may require a different minimum offer. Alternatively, the product may be re-listed for a set unit price.

In an alternative embodiment of the invention, a special type of listing permits floating variables, allowing the principles to adjust parameters of the listing on the fly to optimize their respective interests. For licensors 10, the minimum aggregate licensing fee or minimum acceptable offer may be adjusted. For offerors 12, an offer may be made stipulating a finite duration, or the amount of the offer may be adjusted prior to the end of the listing. Other variations may also be possible.

In another alternative embodiment of the invention, offers On made by offerors 12 may be subsidized by a third party in exchange for the inclusion of advertising content either with the delivered product or on the web pages displayed by web server 100. In this embodiment of the invention, an advertiser may subsidize the offer of a particular offeror 12 based on any criteria, for example, the offeror's profile or past experience. The subsidies may be a set amount or may be in different amounts depending on the advertiser's evaluation of each offeror 12, or may include different advertisements depending upon an offeror's profile or interests. The subsidy amount and type of advertising is determined by subsidy module 114. The amount of the subsidy is handed off to offer processing module 106 and is added to the offer Oₙ of offeror 12 to form subsidized offer Oₛ.

The subsidy may entice interested parties to make offers, and may help to increase a greater number of offers over the minimum acceptable offer, if one has been specified. In all cases, the subsidy will help the aggregate offer to reach the minimum aggregate licensing fee specified by licensor 10 sooner.

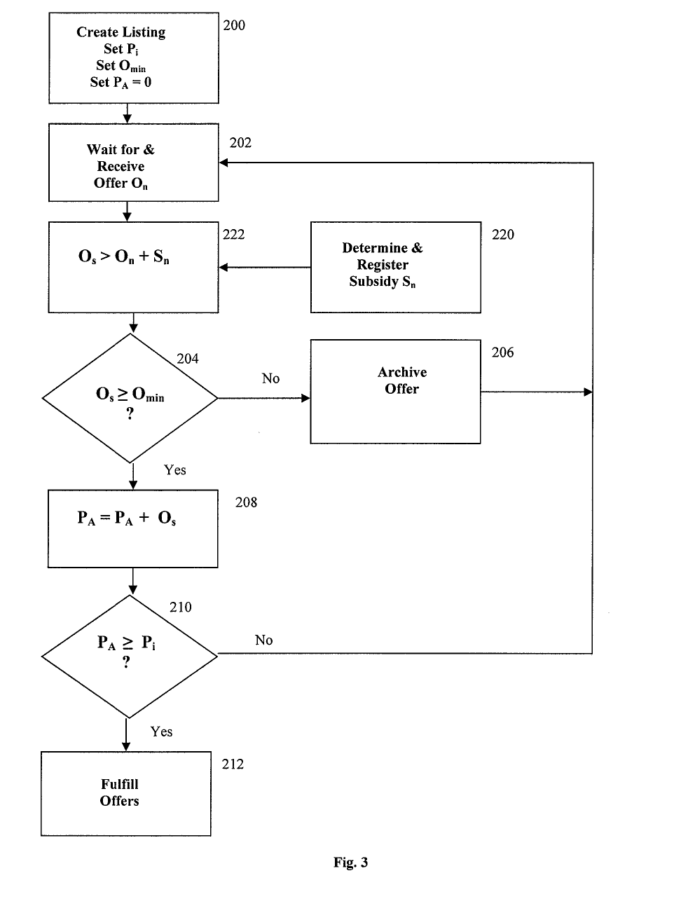

This embodiment of the invention is shown in FIG. 3. FIG. 3 is identical to FIG. 2 with the exception of the addition of boxes 220 and 222. In box 220, the subsidy to be added to a particular offer is determined, preferably via an analysis of offeror 12, but any other means may be used to determine the subsidy, including providing a set subsidy for all offers. In box 222 the determined subsidy is added to the offer Oₙ to create a subsidized offer Oₛ.

In another aspect of the invention, a profit sharing model has been created to allow successful licensees 12 to share in the profits generated by additional sales of the product. In this aspect of the invention, in subsequent listings of the work, the licensor may choose to share a percentage of subsequent net revenues with those who initially made offers above the minimum acceptable offer, in proportion to their original offers. For example, if the minimum acceptable offer was 50 cents, and successful licensees made offers equal to or in excess of 50 cents, those licensees would share a pro rata portion of a percentage of future revenues generated by the work, in proportion to the amount of their offer, or the amount of their offer exceeding the minimum offer. These people are thus designated as “patrons” who helped launch the product and will share the profits thereafter. Licensor 10 may designate a percentage of future profits to be shared in the original listing of the product to entice offerors to make offers above the minimum acceptable offer. After licensor 10 receives his initial price (Pᵢ) he may then re-list the same work for subsequent aggregate licensing, or offer it for a flat fee. If the subsequent listing is successful then the specified percentage of the revenue generated by that offering will be distributed among the patrons who initially made a successful offer. Profit sharing module 116 is responsible for calculating the shared profit for each of the patrons, and for distributing that profit. Each patron's share will be determined on a pro-rata basis by the equation

D=(r*p*Oₙ)/Pᵢ
Where:
D is the patron's share;
r is the percentage of the profits to be shared;
p is the subsequent aggregate licensing totals;
Oₙ is any qualified offers from previous listing above the minimum acceptable offer; and
Pᵢ is the initial price.

The pro-rata share may be determined by the initial offer made by the successful licensee or the initial offer minus any minimum required offer. Note that a hidden benefit of the profit sharing is to discourage the illegal sharing of licensed products, because licensees 12 have a vested interested in the continued marketing and sale of the work.

In yet another aspect of the invention, it is also possible that the present application may be applied to tangible goods when an economy of scale is required prior to manufacturing to either launch new products or to lower per unit costs of the product. Typically, items in this category would include tangible goods at the pre-manufacture stage. As an example, a small private aircraft manufacturer may list his aircraft and invite offers as preorders for building several of the aircrafts. Often in the case with such products, the number of vehicles to be built greatly effects the single user pricing. It may be the case that the aircraft can only be produced economically when a minimum number of the aircraft are ordered. Alternatively, the method can also be used to lower the per unit costs. For example, a manufacturer may determine a single aircraft can be built for $350,000, four aircrafts can be built for $200,000 each or ten aircrafts can be built at $110,000. Interested parties would make their offers at the price that they are willing to pay. For example, one may offer $200,000 and hope that three others will make the same offer, or that nine others would make offers of $110,000 so they all can get the aircraft at the discounted price.

Note that the examples of implementations given herein are for exemplary purposes only and are not intended to limit the scope of the invention, which is set forth in the claims which follow.

I claim:

1. A method for licensing a product for a minimum licensing fee, comprising the steps of:
a. accepting offers from a plurality of offerors;
b. aggregating said offers;
c. checking to see if the sum of said aggregated offers equals or exceeds said minimum licensing fee; and
d. if said minimum licensing fee is equaled or exceeded, granting a license to use said product to said plurality of offerors.

2. The method of claim 1 further comprising the steps of:
a. collecting respective offers from said plurality of offerors; and
b. rendering payment in the amount of said aggregated offers to the licensor of said product.

3. The method of claim 1 further comprising the step of collecting a fee from the potential licensor of said product prior to accepting said offers.

4. The method of claim 2 further comprising the step of subtracting a fee from the amount of said aggregated offers prior to rendering payment to said licensor.

5. The method of claim 1 wherein said offers are accepted for a predetermined period of time or until said aggregated offers equal or exceed said minimum licensing fee.

6. The method of claim 1 wherein said product is posted on a web page served by a web server.

7. The method of claim 6 wherein said web server maintains a database of potential offerors and further wherein an offeror must be registered in said database before being permitted to tender an offer.

8. The method of claim 6 wherein said web server maintains a plurality of products for which offers for licenses are accepted, further comprising a search facility to allow a plurality potential offerors to search for products of interest among said plurality of products.

9. The method of claim 6 further comprising a facility for collecting payment from said licensees and rendering payment to said licensor.

10. The method of claim 6 further comprising a facility for the storage of said products.

11. The method of claim 6 further comprising a facility for delivering or allowing delivery of said licensed product to said plurality of offerors.

12. The method of claim 1 wherein said offers must exceed a minimum offer amount.

13. The method of claim 12 wherein said minimum offer amount is unknown to said plurality of offerors when said offers are made.

14. The method of claim 1 further comprising the step of allowing one or more third parties to provide subsidies to individually accepted offers.

15. The method of claim 14 wherein said subsidies are added to said individual offers before they are aggregated.

16. The method of claim 15 wherein said subsidy provided to individual offerors is determined on a per-offeror basis, and wherein said subsidy may be different for different offerors.

17. The method of claim 15 wherein said one or more third parties may attach advertising to said product prior to its delivery to said offerors, in exchange for said subsidy.

18. The method of claim 12 wherein offerors submitting an offer exceeding said minimum offer amount may share in a percentage of future profits earned from the licensing of said product.

19. The method of claim 18 wherein said percentage of future profits to be shared with said offerors submitting an offer exceeding said minimum offer amount is set by said licensor at the time of the initial offering of said product.

20. The method of claim 18 wherein said percentage of future profits is split among said offerors submitting an offer exceeding said minimum offer amount on a pro rata basis based upon the amount of each offer in excess of said minimum offer amount.

21. The method of claim 1 wherein said minimum licensing fee may be adjusted up or down prior to having said minimum licensing fee equaled or exceeded by the aggregate of said plurality of offers.

22. The method of claim 1 wherein any one of said plurality of offers may be valid only for a limited time, during which said minimum licensing fee must be equaled or exceeded.

23. The method of claim 12 wherein said minimum offer amount may be adjusted prior to having said minimum licensing fee equaled or exceeded by the aggregate of said plurality of offers.

24. The method of claim 1 wherein any one of said plurality of offers may be adjusted prior to having said minimum licensing fee equaled or exceeded by the aggregate of said plurality of offers.

25. A method of accepting a minimum number of orders at a set price for a tangible product, comprising the steps of:
a. advertising said tangible product at one or more prices, said prices being determined by the minimum number of offers required at each of said prices;
b. accepting offers from a plurality of offerors at one of said one or more prices;
c. checking to see if the number of offers at any one of said one or more prices exceeds the required minimum number of offers at that price; and
d. delivering said tangible product to each of said offerors submitting offers at or above said price for which a minimum number of offers have been received.
